(19) United States
(12) Patent Application Publication
(10) Pub. No.: US 2007/0129941 A1
(43) Pub. Date: Jun. 7, 2007

(54) Preprocessing system and method for reducing FRR in speaking recognition

(75) Inventor: Clifford Tavares, San Carlos, CA (US)

Correspondence Address: SQUIRE, SANDERS & DEMPSEY L.L.P., 1 MARITIME PLAZA, SUITE 300, SAN FRANCISCO, CA, 94111, US

(73) Assignee: Hitachi, Ltd.

(21) Appl. No.: 11/292,602

(22) Filed: Dec. 1, 2005

(51) Int. Cl. G10L 21/02

(52) U.S. Cl. 704/226

(57) ABSTRACT

Embodiments of a system, method and computer program product of adapting the performance of a biometric system based on factors relating to a characteristic (e.g., quality) of an input sample are described. In accordance with one embodiment, data about one or more factors relating to a characteristic of an input sample is collected. For each of the one or more factors, a constant is determined. The constants are averaged to derive a shift value that is used as a basis for adjusting an equal error rate value of the biometric system.

### TECHNICAL FIELD

Embodiments described herein relate generally to signal processing and more particularly, to speech signal processing for speech-based biometric systems.

### BACKGROUND

The accuracy of voice- or speech-based biometrics systems can depend quite largely on the quality recording environment in which speech samples are captured by the given biometric system. A poor quality recording environment can cause an increase in the false rejection rate of the biometric system. Therefore, an adaptation method is needed in order to help improve the false rejection rate under poor recording conditions.

### SUMMARY

Embodiments of a system, method and computer program product of adapting the performance of a biometric system based on factors relating to the quality of an input sample are described. In accordance with one embodiment, data about one or more factors relating to the quality of an input sample. For each of the one or more factors, a constant is determined. The constants are averaged to derive a shift value that is used as a basis for adjusting an equal error rate value of the biometric system.

In one embodiment, the sample can comprise speech. In such an embodiment, the one or more factors can include: (1) a factor based on a signal to noise ratio of the speech; (2) a factor based on a dynamic range of the speech; (3) a factor representing a proportion of unvoiced to voiced frames in the speech; (4) a factor derived from a proportion of repeating content in the speech; (5) a factor derived from speech zones in the speech; and/or (6) a factor based on a frequency response curve of the microphone used to capture the speech.

Some of the constants can be inversely proportional to their associated factor. For example, the constant associated with the factor based on the signal to noise ratio of the speech can be inversely proportional to the signal to noise ratio of the speech. Likewise, the constant associated with the factor based on the dynamic range of the speech can be inversely proportional to the dynamic range of the speech. The constant associated with the factor derived from speech zones in the speech can also be inversely proportional to the proportion of speech zones in the speech. Further, the constant associated with the factor based on the frequency response curve of the microphone can be inversely proportional to the frequency response curve of the microphone.

Other constants can be proportional to their associated factor. For example, the constant associated with the factor representing the proportion of unvoiced to voiced frames in the speech can be proportional to the proportion of unvoiced to voiced frames in the speech. Similarly, the constant associated with the factor derived from the proportion of repeating content in the speech can be proportional to the proportion of repeating content in the speech.

In one embodiment, the equal error rate value can be adjusted using the shift value to improve the false acceptance rate of the speaker recognition system. In another embodiment, the shift value can be subtracted from equal error rate value.

### BRIEF DESCRIPTION OF THE DRAWINGS

FIG. 1 is a schematic block diagram of an exemplary speech or voice-based biometric recognition system in accordance with an embodiment.

FIG. 2 shows an illustrative flat frequency response curve in accordance with an exemplary embodiment;

FIG. 3 illustrates an exemplary non-uniform speech response curve in accordance with an exemplary embodiment;

FIG. 4 illustrates another exemplary non-uniform speech response curve in accordance with an exemplary embodiment;

FIG. 5 is a representation of an illustrative unvoiced waveform as expressed by amplitude vs. time;

FIG. 6 is a representation of an illustrative voiced waveform as expressed by amplitude vs. time;

FIG. 7 is a graph of an exemplary response curve of a speech-based biometric system;

FIG. 8 is an representation of the calculation of a final shift value from a plurality of environmental/recording factors;

FIG. 9 is a graph of the application of an illustrative final shift value applied an exemplary response curve of a speech-based biometric system; and

FIG. 10 is a flowchart of a process of adapting the performance of a biometric system based on factors relating to the quality of an input sample.

### DETAILED DESCRIPTION

Embodiments are described for improving false rejection rate performance of a speech-based biometric system by analyzing speech input into the biometric system during a pre-processing stage. The results of the analysis may then be used to predict an affect on the response of the speech-based biometric system and apply a correction to improve the response of the speech based biometric system.

### Recognition System

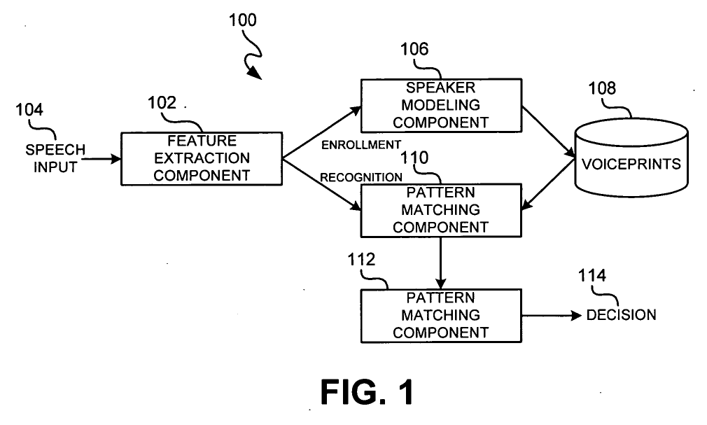

FIG. 1 is a schematic block diagram of an exemplary speech or voice-based biometric recognition system 100 (“speaker recognition system”) for implementing various embodiments described herein. Embodiments of the speaker recognition system 100 may be used for enrolling new speakers (e.g., “enrollees” with known identities) into the system as well as for performing speaker identification and/or speaker verification (collectively referred to as “speaker recognition”) using speech samples obtained from speakers (e.g., “claimants” with unknown or unconfirmed identities) in order to determine and/or confirm their identities.

The front end of the speaker recognition system may include a feature extraction component 102 (“feature extractor”) for receiving a sample of speech 104 from a speaker obtained using, for example, a microphone coupled to the feature extractor. The feature extractor 102 or some other pre-processing component can convert the input speech sample 104 into a digitized format which the feature extractor 102 can then convert into a sequence of numerical descriptors known as feature vectors. The elements (sometimes referred to as “features” or “parameters”) of the feature vectors typically provide a more stable, robust, and compact representation than the raw input speech signal. Feature extraction can be considered as a data reduction process that attempts to capture the essential characteristics of the speaker with a small data rate.

During enrollment of a speaker, a speaker model or template is created from the feature vectors. As shown in FIG. 1, the template may be created by a speaker modeling component 106. This template can be stored in a template database 108.

Once enrolled, recognition of the user can be performed. In the recognition, features are extracted from the speech sample of an unknown speaker (i.e., the claimant) and subject to pattern matching by a patterning matching component 110 of the system. Pattern matching can refer to an algorithm or set of algorithms that compute a match score based on a comparison between the claimant's unknown speaker's feature vectors and the template stored in the database that is associated with the identity claimed by the claimant. The output of the pattern matching module is a similarity (or dissimilarity) score that is a numerical representation of the degree of similarity between the speaker's speech sample and the compared template. The term “similarity” as in “similarity score” should include the alternative “dissimilarity” test.

The system may also include a decision module 112 that receives the match scores as an input and makes a decision 114 on the speaker's claim of identity. The decision 114 may also be output with a confidence value that represents a measure of confidence in the decision.

The type of the decision depends on the particular implementation. For example, in a verification implementation, a binary decision may be made as to whether to accept or reject the speaker (i.e., yes the speaker is the claimed identity or no the speaker is an imposter). Two other possibilities can be used in an identification implementation. First, in a closed-set identification implementation, the decision is which registered user (i.e., which enrollee) in the system is most similar to the unknown speaker. Second, in an open-set identification implementation, an additional decision is made as to whether the unknown speaker does not match any of the speakers registered with the system.

### Feature Extraction

In general, feature extraction may be defined as a process where higher-dimensional original vectors are transformed into lower-dimensional vectors. Thus, feature extraction may be considered a mapping. There are several reasons why feature extraction is useful. For example, in order for the statistical speaker models to be robust, the number of training samples should be large enough compared to the dimensionality of the measurements. The number of training vectors needed grows exponentially with the dimensionality. Also, feature extraction helps to reduce computational complexity.

In a speaker recognition system, an optimal feature may include some or all of the following properties: (1) high inter-speaker variation; (2) low intra-speaker variation; (3) easy to measure; (4) robust against disguise and mimicry; (5) robust against distortion and noise; and (6) maximally independent of the other features. Properties (1) and (2) suggest that the features used by the system be as discriminative as possible. The features should also be easily measurable. To be easily measurable, a feature may be one that occurs relatively frequently and naturally in speech so that it can be extracted from short speech samples. A good feature may also be robust against several factors such as voice disguise, distortion and noise. Also, feature can be selected so that they are maximally independent of each other.

Technical error sources can also degrade the performance of a speaker recognition system. Exemplary technical error sources include environmental or additive noise source such as background noise, environmental acoustics, echoing. There may also be channel or convolutive noise sources such as microphone distortion, recording interference, band-limiting or A/D quantization noise, and speech coding. In general, these kinds of noise are considered relatively stationary in short term, have zero mean, and are uncorrelated with the speech signal. In speaker recognition systems, user speech is recorded with some sort of microphone which can pick up environmental noise that adds to the speech wave. In addition, reverberation can add delayed versions of the original signal to the recorded signal. Nonlinear distortion can also be added to the true speech spectrum. An A/D converter can also add its own distortion.

### Factors Affecting Accuracy

In general, the accuracy of a speaker recognition system can depend on two factors: (1) the accuracy of the speech-based biometric algorithm used by the system; and (2) the recording and environmental conditions of speech captured by and/or input into the biometric system. Environment and/or recording factors affecting the accuracy of a speech-based biometric algorithm can include: signal to noise ratio, recording volume, microphone quality, and various speech content factors such as unvoiced to voiced distribution, repetition in the content, and speech/no-speech zones.

Implementation of the embodiments described herein can be used to help address the effect of environment and recording conditions on a speaker recognition system. In accordance with one embodiment, various environmental/recording factors can be collected and analyzed during a pre-processing stage of a recognition system as follows.

(1) Signal-to-noise ratio: Signal-to-noise ratio (“SNR”) is a factor that can affect the quality of recorded speech/voice. For instance, poor or bad signal to noise ratio values/levels can result in the loss of speech details. As a result, recordings with low speech details can, in turn, yield poor recognition results in a biometric recognition system.

Signal-to-noise ratio levels can be calculated using the following exemplary algorithm:
SNR=10*log(Signal Voltage/Noise Voltage)

As a rule of thumb, 3 bits=1 dB. In a speech-based biometric system, 18 dB or more may be considered to be a good signal-to-noise ratio while a signal-to-noise ratio of 10 dB or less may be considered bad or poor.

To collect information about the signal to noise environmental factor for a given recording environment of a speech-based biometric recognition system, the noise level in the microphone output under a “no signal” condition can be measured. A signal to noise ratio algorithm, such as the previously described exemplary algorithm, may then be used to compute the signal-to-noise ratio of the given recording environment.

(2) Recording volume: The recording volume, more specifically, the dynamic range (“DR”) of the recording volume can also be one of the factors affecting accuracy of a biometric recognition system. A better dynamic range can result in better resolution in the time and frequency domains and, as a result, can lead to better recognition results by a speech-based biometric recognition system. For example, the recommended recording level for an illustrative 16 bits-per-sample recording can be between +/−20000 Hz to +/−32000 Hz or have a target signal-to-noise ratio between 14.3 dB to 48.0 dB.

One way to compute the dynamic range for a given biometric system can be accomplished by examining the peak positive and negative values.

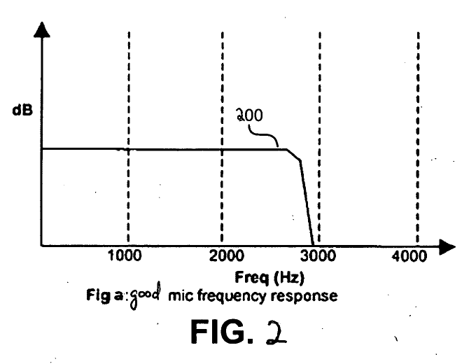

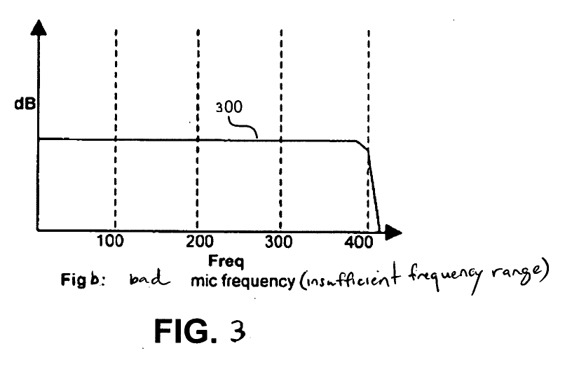

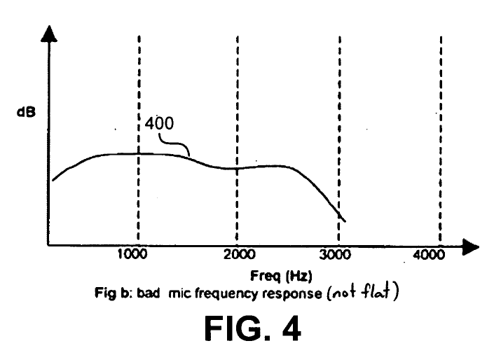

(3) Microphone quality: The frequency response curve (“FRC”) of a microphone can be a factor affecting the accuracy of a biometric system. For example, a microphone with a good frequency response curve should have generally uniform frequencies across the entire voice band (i.e., a flat frequency response) across a voice band. FIG. 2 shows an illustrative flat frequency response curve 200 generated from speech captured from a good quality microphone. A microphone exhibiting such properties can be considered a good quality microphone. In contrast, poor quality microphones typically have frequency responses curves with non-uniform frequencies across the speech band. FIGS. 3 and 4 illustrate exemplary speech bands that may be generated from speech captured by poor quality microphones. Specifically, FIG. 3 illustrates a response curve 300 generated from speech captured by a poor quality microphone, the curve 300 having insufficient frequency range. FIG. 4 illustrates speech captured by a poor quality microphone, the curve 400 having a non-uniform frequency response.

A variety of methods may be used to determine the frequency response of a microphone. For example, the voice bandwidth can be divided into “bins” so that the average energy in a bin over a period of time can be computed in response to a multi-tone signal.

(4) Speech content factors: The content of speech input (i.e., spoken utterance(s) such as, e.g., spoken password(s)) into a biometric system can have a direct relationship to the performance of the biometric system. The content of the input speech can include one or more the following characterizations: (1) unvoiced to voiced frame distribution (“UVD”); (2) repetition of content; and (3) speech vs. no-speech zones.

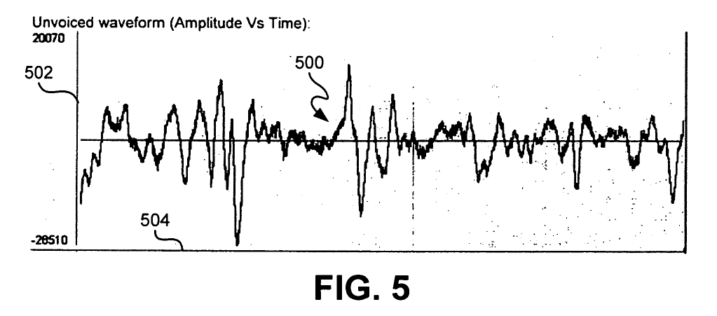

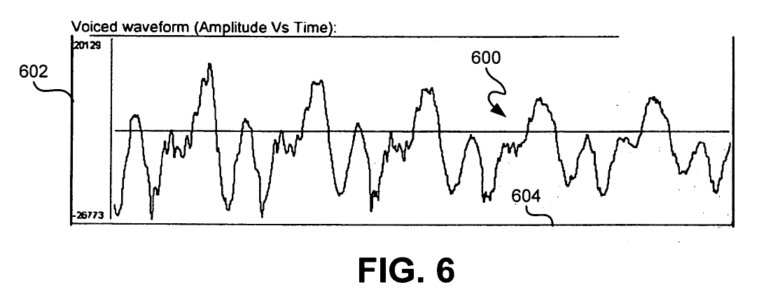

(a) Unvoiced to voiced distribution: FIG. 5 shows an illustrative unvoiced waveform 500 as expressed by amplitude 502 vs. time 504. FIG. 6 shows an illustrative voiced waveform 600 as expressed by amplitude 602 vs. time 604. A comparison of the two waveforms in FIGS. 5 and 6 provides an explanation why voiced frames may be more reliable for speech recognition purposes than unvoiced frames. As can be seen in FIGS. 5 and 6, voiced frames are typically more periodic than unvoiced frames with the unvoiced frames being very similar to random noise frames/waveforms. As a result of their more periodic (i.e., less random) nature, voiced frame may, therefore, be more reliable for speaker recognition purposes than unvoiced frames.

There are a variety of voiced to unvoiced (or unvoiced to voiced) classifiers that may be used in the characterization of speech samples used in a biometric system. For example, one classification method, known as the maximum likelihood detection, expresses the unvoiced to voiced distribution of a speech sample as a ratio of the unvoiced. The maximum likelihood detection method is further described in a reference by B. S. Atal entitled, “Automatic speaker recognition based on pitch contours” J. Acoust. Soc. Amer., vol. 52, pp. 1687-1697, 1972 which is incorporated herein by reference.

(b) Repetition of content: The accuracy in recognizing a given utterance (e.g., a spoken password) by a biometric system can be proportional to the diversity of content in the utterance. For example, in the two following illustrative utterances: (1) “check, one, two, three” and (2) “one, one, one,” the second utterance “one, one, one” is expected to have less recognition accuracy than the first utterance because of the lack of diversity in the content of the second utterance.

The presence of repetitive content can be determined by analyzing the voice spectrum of an utterance over time. As another option, an average of the cepstrum can be analyzed to determine whether content is redundant (i.e., repetitive).

(c) Speech vs. no-speech zones: The lengths of speech and no-speech (or non-speech) zones in an utterance can also be factor affecting the accuracy of a speech-based biometric system. Typically, longer durations of actual speech in a recorded segment of voice (i.e., utterance) can result in greater accuracy by the biometric system. Thus, by identifying and separating speech zones from no-speech zones in an utterance so that a biometric system can analyze the speech zones independently and/or exclude no-speech zones from the analysis of the speech sample. A voice activity detector (VAD) using one or more of the various known voice detection algorithms can be used to separate speech from no-speech zones.

While the above-described factors and collection methods for these factors are exemplary, it should be understood that there may be other methods for collecting and analyzing these factors known to one of ordinary skill in the art.

### Applying Equal Error Rate Correction

After the various factors that can affect the accuracy of a speech-based biometric system have been collected and analyzed (i.e., determined and/or measured), a correction to the equal error rate (EER) (i.e., a correction factor or value) can be calculated from the factors and used in the biometric system. This correction represents a relationship between the collected environment factors and their effect on equal error rate (EER) performance of the given speech-based biometric system.

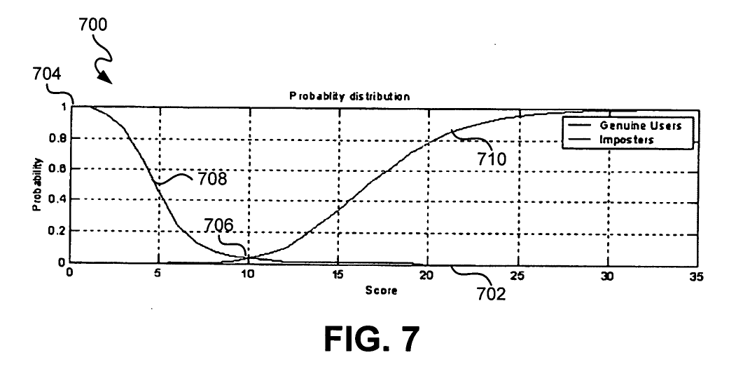

FIG. 7 shows a graph 700 of an exemplary response curve of a speech-based biometric system. In this graph, the response is expressed in the form of a cumulative probability distribution curve that maps the match score (x-axis 702) to the probability (y-axis 704) of a person being valid (i.e., genuine users) or invalid (i.e., imposters). The equal error rate is found at point of intersection 706 between a genuine users cumulative probability distribution function graph 708 and an imposters cumulative probability distribution function graph 710.

The equal error rate, also known as the crossover rate or crossover error rate, may be defined as a point where decision threshold of a biometric system can be set so that the proportion of false rejections will be approximately equal to the proportion of false acceptances. Typically, the lower the equal error rate value, the higher the accuracy of the biometric system.

With the graph 700 of FIG. 7 in mind, assume “x” to be a constant that determines the position of the imposter curve 710 in FIG. 7. Large values of “x” can indicate large shifts to the left of the curve, thereby increasing the value of the EER point. The increased-value EER point causes the reduction of the false rejection rate (FRR) and thereby helps increase overall recognition accuracy of the biometric system.

The following algorithms can be used to describe six relationships between the collected environmental parameters and the position the constant “x” for a given speech-based biometric system:
R1→SNRα1/x;
R2→DRα1/x;
R3→FRCα1/x;
R4→UVDαx
R5 →RCαx; and
R6 →VADα1/x;
   where:
SNR is the signal to noise ratio associated with the biometric system;
DR is the dynamic range associated with the biometric system;
FRC is the frequency response curve associated with the biometric system;
UVD is the unvoiced-voiced distribution associated with speech input into the biometric system (e.g., a speech sample captured by the biometric system);
RC is the proportion of repeated content associated with speech input into the biometric system; and
VAD relates to the zones of speech identified in the speech input into the biometric system.

The above algorithms can be converted into line equations by defining a constant in each relationship above. Alternatively, the value A1 may have a nonlinear or a piecewise linear relationship with the value depending on the instantaneous value of SNR. For example:
R1=SNR*A1/x

These constants (such as, e.g., A1) may be highly dependant on the relative effect of each of these methods on the value of “x.” This determination can be, is some cases, subjective. For example, in the case of the signal-to-noise ratio, SNR, the defining of the associated constant may depend on the particular nature of background noise (e.g., periodic, impulsive, white, etc). In addition, the values assigned to these constants can reflect the relative importance of each of these parameters on the overall performance of the given speech-based biometric system. For example, it may be found that poor FRC values have a larger impact on performance of the biometric system than the other parameters.

The final shift value “X” can be defined as the average sum of affects of each of the parameters:
X=sum(A[n])/n
where:
n varies is the total number of environmental factors being considered (e.g., a number between 1-6);
A[n] is an array of weighted constants (described above); and
X is the final shift value.

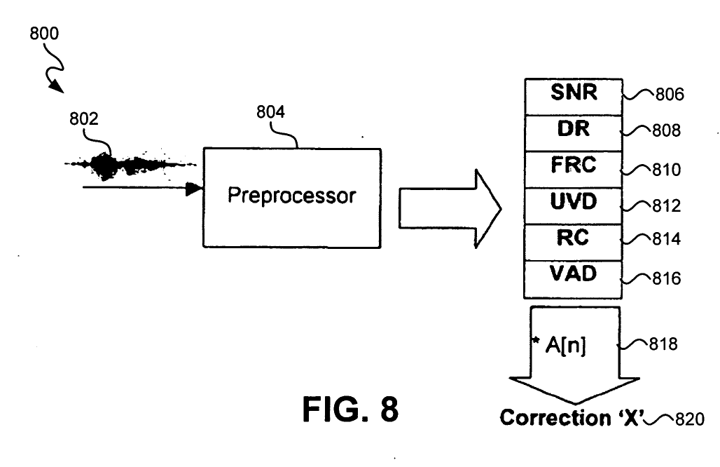

FIG. 8 is an representation 800 of the calculation of a final shift value X (referred to as “Correction ‘X’”) from a plurality of environmental/recording factors. As can be seen in FIG. 8, an input speech sample 802 is processed by a preprocessing component 804 (preprocessor) of a biometric system to generate various environmental parameters (e.g., SNR 806, DR 808, FRC 810, UVD 812, RC 814, and VAD 816). From the derived parameters, an array of weighted constants 818 can be used to generate the final shift value X 820. The preprocessor 804 can collect the various factors, generate the parameters, and derive the final shift value X using, for example, the previously described algorithms and processes.

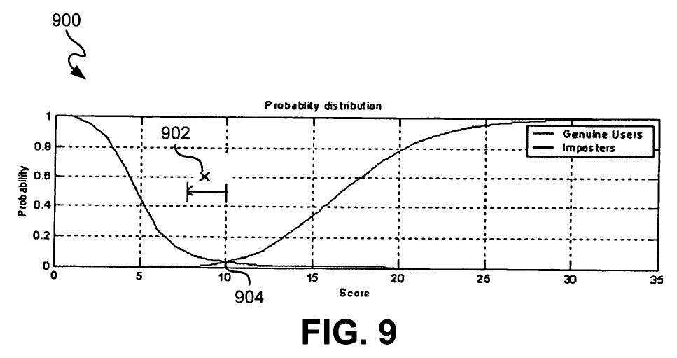

FIG. 9 shows a graph 900 (similar to graph 800 in FIG. 8) of the application of an illustrative final shift value X 902 applied an exemplary response curve of a speech-based biometric system. In this graph, the final shift value X 902 shifts the effective value of the equal error point 904 to the left, thereby helping to improve the false rejection ration response of the biometric system.

Since the embodiments described herein may be performed at the pre-processing stage, these embodiments can be used to enhance accuracy of a variety of speech-based biometric systems including off-the-shelf voice biometrics solutions. Further, these embodiments may also help speech-based biometric algorithms adapt better to imperfect recording environments.

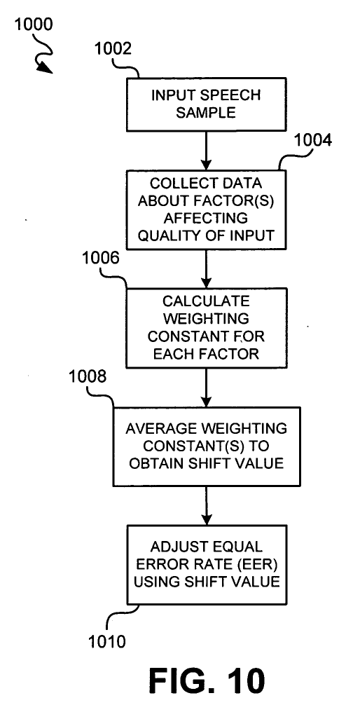

FIG. 10 is a flowchart of a process of adapting the performance of a biometric recognition system based on factors relating to the characteristics (e.g., quality) of an input sample in accordance with an exemplary embodiment. Such a process may be implemented, for example, using a computer. As shown in FIG. 10, a sample can be captured or received in operation 1002. The sample can be input by a user into the biometric recognition system. In operation 1004, data can be collected about one or more factors or parameters relating to the characteristics (e.g., quality) of an input sample.

In operation 1006, a weighting constant for each of the one or more factors can be determined or calculated thereby resulting in one or more weighting constants (depending on the number of factors involved). In operation 1008, the calculated weighting constants can be averaged to derive a shift value that, in operation 1010, can be used to adjust the equal error rate value of the biometric recognition system. In one embodiment, the equal error rate value can be adjusted based on the shift value to improve (i.e., reduce) the false rejection rate of the speaker recognition system. For example, the shift value can be subtracted from equal error rate value (so that the equal error rate value is reduced by the shift value).

In one embodiment, the biometric recognition system can comprise a speech-based biometric recognition system. In such an embodiment, the sample comprises a speech sample input, for example, by the user and captured using a microphone. In such an embodiment, the factors can include: a factor based on a signal to noise ratio of the input speech signal/sample; (2) a factor based on a dynamic range of the input speech sample/signal; (3) a factor representing a proportion of unvoiced to voiced frames in the input speech sample/signal; (4) a factor derived from a proportion of repeating content in the input speech sample/signal; (5) a factor derived from speech zones in the input speech sample/signal (e.g., speech zones that have been separated from no-speech zones in the speech sample/signal); and/or (6) a factor based on a frequency response curve of the microphone.

Some of the weighting constants can be inversely proportional to their associated factor. For example, the weighting constant associated with the factor based on the signal to noise ratio of the speech signal can inversely proportional to the signal to noise ratio of the speech signal/sample. The weighting constant associated with the factor based on the dynamic range of the speech signal can also be inversely proportional to the dynamic range of the speech signal/sample. The weighting constant associated with the factor derived from speech zones in the input speech sample/signal can also be inversely proportional to the proportion of speech zones in the input speech sample/signal. As a further example, the weighting constant associated with the factor based on the frequency response curve of the microphone can be inversely proportional to the frequency response curve of the microphone.

Other weighting constants can be proportional to their associated factor. For example, the weighting constant associated with the factor representing the proportion of unvoiced to voiced frames in the input speech sample/signal can be proportional to the proportion of unvoiced to voiced frames in the input speech sample/signal. As another example, the weighting constant associated with the factor derived from the proportion of repeating content in the input speech sample/signal is proportional to the proportion of repeating content in the input speech sample/signal.

The various embodiments described herein may further be implemented using computer programming or engineering techniques including computer software, firmware, hardware or any combination or subset thereof. While components set forth herein may be described as having various sub-components, the various sub-components may also be considered components of the system. For example, particular software modules executed on any component of the system may also be considered components of the system. In addition, embodiments or components thereof may be implemented on computers having a central processing unit such as a microprocessor, and a number of other units interconnected via a bus. Such computers may also include Random Access Memory (RAM), Read Only Memory (ROM), an I/O adapter for connecting peripheral devices such as, for example, disk storage units and printers to the bus, a user interface adapter for connecting various user interface devices such as, for example, a keyboard, a mouse, a speaker, a microphone, and/or other user interface devices such as a touch screen or a digital camera to the bus, a communication adapter for connecting the computer to a communication network (e.g., a data processing network) and a display adapter for connecting the bus to a display device. The computer may utilize an operating system such as, for example, a Microsoft Windows operating system (O/S), a Macintosh O/S, a Linux O/S and/or a UNIX O/S. Those of ordinary skill in the art will appreciate that embodiments may also be implemented on platforms and operating systems other than those mentioned. One of ordinary skilled in the art will also be able to combine software with appropriate general purpose or special purpose computer hardware to create a computer system or computer sub-system for implementing various embodiments described herein. It should be understood the use of the term logic may be defined as hardware and/or software components capable of performing/executing sequence(s) of functions. Thus, logic may comprise computer hardware, circuitry (or circuit elements) and/or software or any combination thereof.

Embodiments of the present invention may also be implemented using computer program languages such as, for example, ActiveX, Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

Based on the foregoing specification, embodiments of the invention may be implemented using computer programming or engineering techniques including computer software, firmware, hardware or any combination or subset thereof. Any such resulting program—having computer-readable code—may be embodied or provided in one or more computer-readable media, thereby making a computer program product (i.e., an article of manufacture) implementation of one or more embodiments described herein. The computer readable media may be, for instance, a fixed drive (e.g., a hard drive), diskette, optical disk, magnetic tape, semiconductor memory such as for example, read-only memory (ROM), flash-type memory, etc., and/or any transmitting/receiving medium such as the Internet and/or other communication network or link. An article of manufacture containing the computer code may be made and/or used by executing the code directly from one medium, by copying the code from one medium to another medium, and/or by transmitting the code over a network. In addition, one of ordinary skill in the art of computer science may be able to combine the software created as described with appropriate general purpose or special purpose computer hardware to create a computer system or computer sub-system embodying embodiments or portions thereof described herein.

While various embodiments have been described, they have been presented by way of example only, and not limitation. Thus, the breadth and scope of any embodiment should not be limited by any of the above described exemplary embodiments, but should be defined only in accordance with the following claims and their equivalents.

What is claimed:

1. A method, comprising:
collecting data about one or more factors relating to a characteristic of an input sample;
determining a constant for each of the one or more factors;
averaging the one or more constants to derive a shift value; and
adjusting an equal error rate value of a biometric system based on the shift value.

2. The method of claim 1, wherein the sample comprises speech.

3. The method of claim 2, wherein the one or more factors includes a factor based on a signal to noise ratio of the speech.

4. The method of claim 3, wherein the constant associated with the factor based on the signal to noise ratio of the speech is inversely proportional to the signal to noise ratio of the speech.

5. The method of claim 2, wherein the one of more factors includes a factor based on a dynamic range of the speech.

6. The method of claim 5, wherein the constant associated with the factor based on the dynamic range of the speech is inversely proportional to the dynamic range of the speech.

7. The method of claim 2, wherein the one of more factors includes a factor representing a proportion of unvoiced to voiced frames in the speech.

8. The method of claim 7, wherein the constant associated with the factor representing the proportion of unvoiced to voiced frames in the speech is proportional to the proportion of unvoiced to voiced frames in the speech.

9. The method of claim 2, wherein the one of more factors includes a factor derived from a proportion of repeating content in the speech.

10. The method of claim 9, wherein the constant associated with the factor derived from the proportion of repeating content in the speech is proportional to the proportion of repeating content in the speech.

11. The method of claim 2, wherein the one of more factors includes a factor derived from speech zones in the speech.

12. The method of claim 11, wherein the constant associated with the factor derived from speech zones in the speech is inversely proportional to the proportion of speech zones in the speech.

13. The method of claim 2, wherein the sample is captured using a microphone.

14. The method of claim 13, wherein the one or more factors includes a factor based on a frequency response curve of the microphone.

15. The method of claim 14, wherein the constant associated with the factor based on the frequency response curve of the microphone is inversely proportional to the frequency response curve of the microphone.

16. The method of claim 1, wherein the equal error rate value is adjusted based on the shift value to improve the false acceptance rate of the speaker recognition system.

17. The method of claim 1, wherein the shift value is subtracted from equal error rate value.

18. A biometric system, comprising:
a preprocessing component capable of receiving a sample for use in biometric recognition:
the preprocessing component having:
logic for collecting data about one or more factors relating to a characteristic of the sample;
logic for determining a constant for each of the one or more factors;
logic for averaging the one or more constants to derive a shift value; and
logic for adjusting an equal error rate value of the biometric system based on the shift value.

19. The biometric system of claim 18, wherein the sample comprises speech.

20. A computer program product having computer code capable of read by a computer, comprising:
computer code for collecting data about one or more factors relating to a characteristic of an input sample;
computer code for determining a constant for each of the one or more factors;
computer code for averaging the one or more constants to derive a shift value; and
computer code for adjusting an equal error rate value of a biometric system based on the shift value.
